(19) United States
(12) Patent Application Publication
(10) Pub. No.: US 2013/0014871 A1
(43) Pub. Date: Jan. 17, 2013

(54) TREAD FOR A PNEUMATIC TIRE

(71) Applicants: Francois Pierre Charles Gerard Georges, Stavelot (BE); Didier Winkin, Bastogne (BE); Lothar Braun, Bollendorf (DE); Frank Pierre Severens, Frassem (BE); Claude Pierre Georges, Luxembourg (LU); Vincent Benoit Mathonet, Habay la Neuve (BE); Daniel Scheuren, Arlon (BE)

(72) Inventors: Francois Pierre Charles Gerard Georges, Stavelot (BE); Didier Winkin, Bastogne (BE); Lothar Braun, Bollendorf (DE); Frank Pierre Severens, Frassem (BE); Claude Pierre Georges, Luxembourg (LU); Vincent Benoit Mathonet, Habay la Neuve (BE); Daniel Scheuren, Arlon (BE)

(21) Appl. No.: 13/182,788

(22) Filed: Jul. 14, 2011

(51) Int. Cl. B60C 11/12

(52) U.S. Cl. 152/209.18

(57) ABSTRACT

A tread for a pneumatic tire includes a first circumferentially continuous groove, a second circumferentially continuous groove, a central rib interposed between the two circumferentially continuous grooves and extending continuously around a circumference of the tread, a first circumferentially extending shoulder rib disposed laterally outside of the first circumferentially continuous groove, and a second circumferentially extending shoulder rib disposed laterally outside of the second circumferentially continuous groove. The central rib has a plurality of circumferentially spaced sipes arranged in a first circumferential row and a second circumferential row. The sipes of the first row originate at the first circumferentially continuous groove and the sipes of the second row originate at the second circumferentially continuous groove. The sipes of both the first and second rows extend axially inward to a circumferentially extending and continuous variable center groove. The variable center groove has a minimum circumferentially extending opening at a radially outermost portion. As the tread wears and the radially outermost portion of the tread moves radially inward, the circumferentially extending opening of the variable center groove widens to a maximum circumferentially extending opening greater than the minimum circumferentially extending opening.

### TECHNICAL FIELD

The present invention relates to a pneumatic tire, and more particularly, to a tread for a pneumatic tire.

### BACKGROUND ART

Pneumatic truck tires constructed for slippery or even winter driving conditions are intended to be suitable for running on surfaces of reduced compactness such as snow-covered roadways. Such tires are required to demonstrate suitable traction (gripping), power, braking, and handling characteristics on wet or snow covered surfaces while maintaining rolling resistance and mileage performance. The tread pattern of commercial truck tires must accordingly meet such competing objectives in order to provide the user with acceptable tire performance.

With the continuing rise in popularity of light trucks and cargo vans, there exists a need to provide tires that have the ability to be driven on paved roads while carrying heavy loads without excessive noise, yet also to be capable of being driven in heavy snow or wet roads. Often these tires will be driven in flooded or wet roadway conditions. As an added condition, these multipurpose traction demands for the tire should be coupled with excellent tread wear.

Historically, tires have been able to meet one or two of the above-referenced performance requirements, but usually at the sacrifice of other design performance features. Snow tires for cargo vans may achieve good traction usually by opening the tread pattern and providing large block type tread elements. However, these tires have been noisy with poor treadwear when driven at highway speeds on paved roads.

A conventional asymmetric nondirectional tire has employed a unique triple traction feature that provides excellent uniform wear across the tread pattern regardless of the wheel position. The tire may have adequate noise and traction characteristics in a variety of conditions, such as snow, off road, on road wet, and on road dry. Another conventional tire has demonstrated a superior wet traction tire by employing two wide aquachannels in combination with the triple traction feature. This tire has demonstrated enhanced deep-water traction without sacrifice of wear and other performance features. While the all around performance of these conventional light truck and sport utility tires should be good, some drivers may have specific needs or concerns requiring a more specialized tire performance in one or more performance features.

Commercial tires should exhibit excellent treadwear and low tire noise on paved roads. The conventional tread for such a vehicle may be a circumferentially ribbed tread. Such a tread may be inherently less noisy than other treads. Lateral grooves may be limited, since lateral grooves may accelerate treadwear. Voids, such as grooves, may provide traction, but a consequential loss of treadwear may result because the net-road contacting area of the tread is reduced by the use of grooves. Further, lateral grooves may create an entry/exit point into/out of the contact patch of the tread thereby initiating additional heel/toe wear.

There is thus a desire to increase traction performance of these ribbed treads without sacrificing treadwear or noise performance the ribbed treads. While these treads wear generally well, irregular wear along the edges of the circumferentially continuous grooves may occur. There has been a trade-off in attempting to increase the aggressive wet road and snow traction performance of these tires while maintaining the treadwear durability and noise constraints.

The present invention seeks to provide a novel tread that is both quiet and long wearing, while also achieving excellent road traction and rolling resistance.

### SUMMARY OF THE INVENTION

A tread for a pneumatic tire in accordance with the present invention includes a first circumferentially continuous groove, a second circumferentially continuous groove, a central rib interposed between the two circumferentially continuous grooves and extending continuously around a circumference of the tread, a first circumferentially extending shoulder rib disposed laterally outside of the first circumferentially continuous groove, and a second circumferentially extending shoulder rib disposed laterally outside of the second circumferentially continuous groove. The central rib has a plurality of circumferentially spaced sipes arranged in a first circumferential row and a second circumferential row. The sipes of the first row originate at the first circumferentially continuous groove and the sipes of the second row originate at the second circumferentially continuous groove. The sipes of both the first and second rows extend axially inward to a circumferentially extending and continuous variable center groove. The variable center groove has a minimum circumferentially extending opening at a radially outermost portion. As the tread wears and the radially outermost portion of the tread moves radially inward, the circumferentially extending opening of the variable center groove widens to a maximum circumferentially extending opening greater than the minimum circumferentially extending opening.

According to another aspect of the tread, the tread further includes a circumferentially extending and continuous variable first groove disposed in the first shoulder rib.

According to yet another aspect of the tread, the tread further includes a circumferentially extending and continuous variable second groove disposed in the second shoulder rib.

According to still another aspect of the tread, the first groove has an axial width increasing from a surface of the first shoulder rib radially inward toward an axis of rotation of the tire.

According to yet another aspect of the tread, the second groove has an axial width increasing from a surface of the second shoulder rib radially inward toward an axis of rotation of the tire.

According to still another aspect of the tread, the variable center groove has an axial width increasing from a surface of the center rib radially inward toward an axis of rotation of the tire.

According to yet another aspect of the tread, the first rib has a first set of circumferentially spaced sipes and a second set of circumferentially spaced sipes.

According to still another aspect of the tread, the second rib has a first set of circumferentially spaced sipes and a second set of circumferentially spaced sipes.

According to yet another aspect of the tread, the first and second circumferentially continuous grooves a 7.6 mm radial depth.

According to still another aspect of the tread, the sipes of the first and second ribs have a radial depth of 100 percent the radial depth of the first and second circumferentially continuous grooves.

A pneumatic tire in accordance with the present invention includes a pair of annular bead cores, a carcass extending around the bead cores to form a toroidal structure, a belt reinforcing structure radially outward of the carcass, and a circumferentially extending tread radially outward of the belt reinforcing structure. The tread includes a first circumferentially continuous groove, a second circumferentially continuous groove, a central rib interposed between the two circumferentially continuous grooves. The central rib extends continuously around a circumference of the tread. A first circumferentially extending shoulder rib is disposed laterally outside of the first circumferentially continuous groove. A second circumferentially extending shoulder rib is disposed laterally outside of the second circumferentially continuous groove. The central rib has a plurality of circumferentially spaced sipes arranged in a first circumferential row and a second circumferential row. The sipes of the first row originate at the first circumferentially continuous groove and the sipes of the second row originate at the second circumferentially continuous groove. The sipes of both the first and second rows extend axially inward to a circumferentially extending and continuous variable center groove. The variable center groove has a minimum circumferentially extending opening at a radially outermost portion. As the tread wears and the radially outermost portion of the tread moves radially inward, the circumferentially extending opening of the variable center groove widens to a maximum circumferentially extending opening greater than the minimum circumferentially extending opening.

According to another aspect of the pneumatic tire, the pneumatic tire further includes a circumferentially extending and continuous variable first groove disposed in the first shoulder rib.

According to still another aspect of the pneumatic tire, the pneumatic tire further includes a circumferentially extending and continuous variable first groove disposed in the first shoulder rib.

According to yet another aspect of the pneumatic tire, the pneumatic tire further includes a circumferentially extending and continuous variable second groove disposed in the second shoulder rib.

According to still another aspect of the pneumatic tire, the first groove has an axial width increasing from a surface of the first shoulder rib radially inward toward an axis of rotation of the tire.

According to yet another aspect of the pneumatic tire, the second groove has an axial width increasing from a surface of the second shoulder rib radially inward toward an axis of rotation of the tire.

According to still another aspect of the pneumatic tire, the variable center groove has an axial width increasing from a surface of the center rib radially inward toward an axis of rotation of the tire.

According to yet another aspect of the pneumatic tire, the first rib has a first set of circumferentially spaced sipes and a second set of circumferentially spaced sipes.

According to still another aspect of the pneumatic tire, the second rib has a first set of circumferentially spaced sipes and a second set of circumferentially spaced sipes.

According to yet another aspect of the pneumatic tire, the first and second circumferentially continuous grooves a 7.6 mm radial depth.

According to still another aspect of the pneumatic tire, the sipes of the first and second ribs have a radial depth of 100 percent the radial depth of the first and second circumferentially continuous grooves.

### BRIEF DEFINITIONS OF THE DRAWINGS

FIG. 1 is a schematic radial plan view of an example tread of a pneumatic tire in accordance with present invention.

FIG. 2 is a schematic cross-sectional view of the pneumatic tire of FIG. 1.

FIG. 3 is a schematic detailed radial plan view of the example tread of FIG. 1 under a first condition.

FIG. 4 is a schematic detailed radial plan view of the example tread of FIG. 1 under a second condition.

### DEFINITIONS

The following definitions are controlling for the present invention.

“Apex” means an elastomeric filler located radially above the bead core and between the plies and the turnup ply.

“Annular” means formed like a ring.

“Aspect ratio” means the ratio of its section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### Detailed Description of an Example of the Present Invention

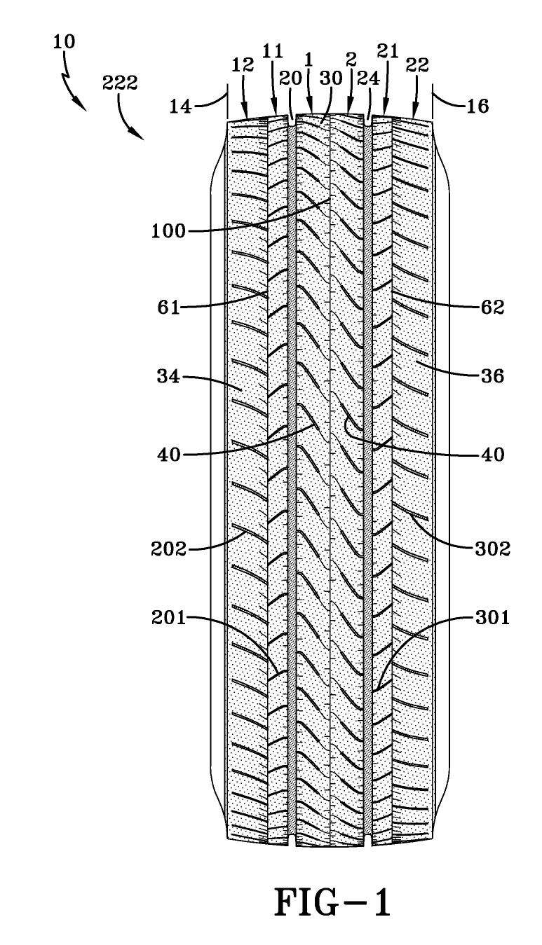

With the reference to FIGS. 1 through 4, a pneumatic tire (10) having a tread (222) according to one example of the present invention is shown. The tread (222) may have an axis of rotation R and first and second lateral edges (14, 16). The tread (222), when used with the pneumatic tire (10), may employ a tire having a carcass (70) with one or more plies (72) reinforced by radially extending synthetic or metal cords and a pair of substantially inextensible bead cores (74), an apex (76) radially above the bead cores (74), and a belt reinforcing structure (77) radially outward of the plies (72). The tire (10) may have an air impervious halobutyl liner (79) and a pair of rubber chafers (78).

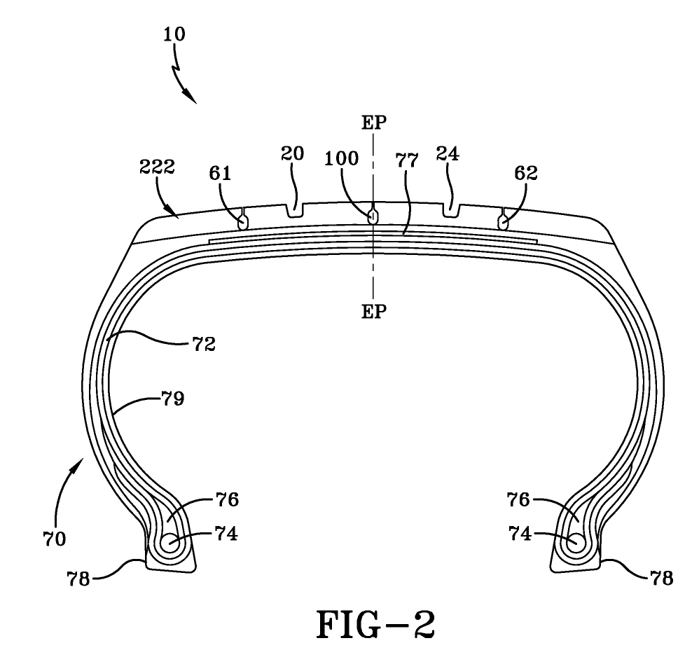

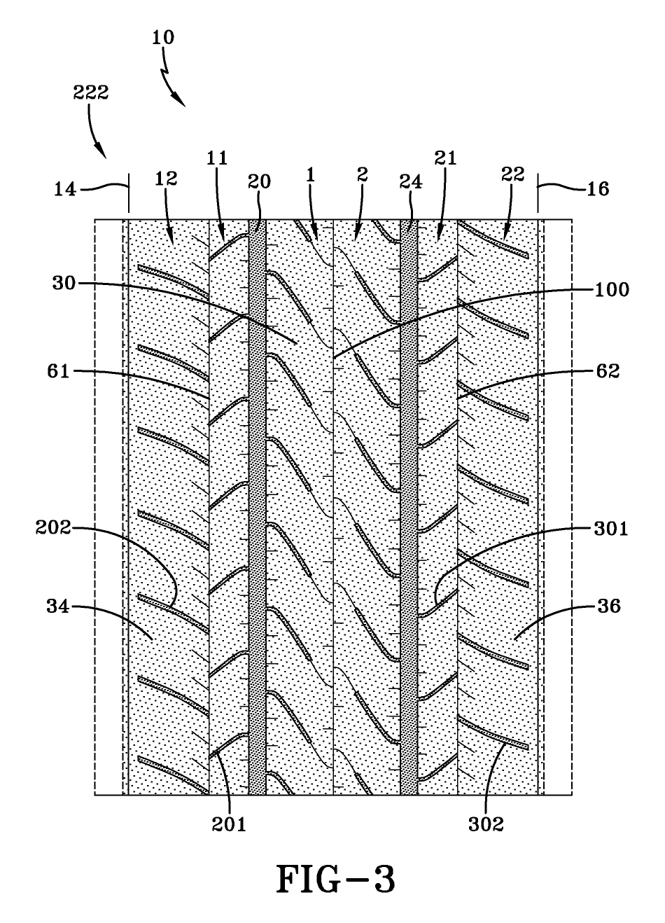

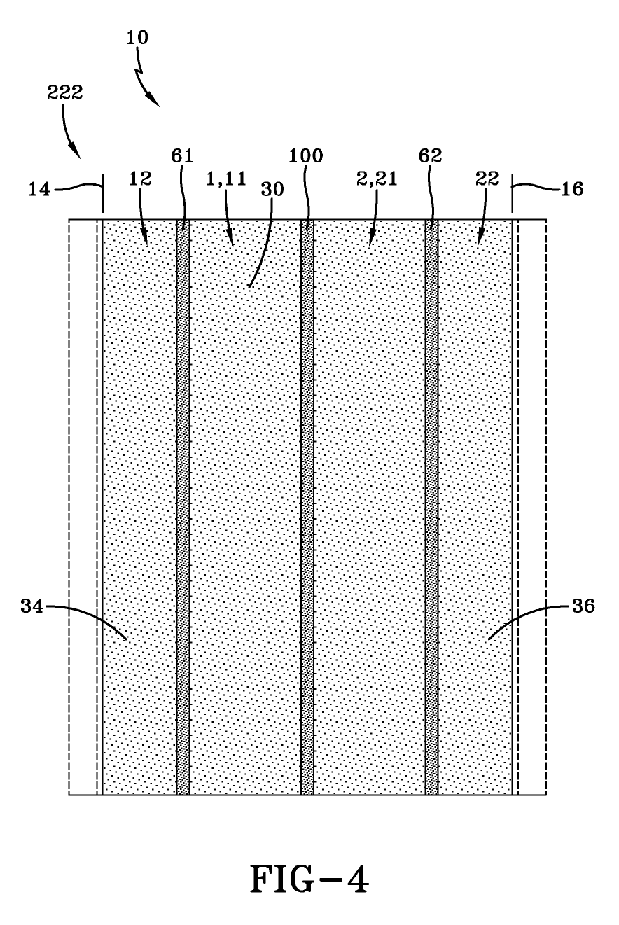

While the carcass (70) and other structures contribute much to the performance of the pneumatic tire (10), the example tread (222) of FIG. 1 may have two circumferentially continuous grooves (20, 24). Interposed between the two circumferentially continuous grooves may be a central rib (30) that extends continuously around the circumference of the tread (222). The central rib (30) may have a plurality of circumferentially spaced sipes (40) arranged in a first row (1) and a second row (2). The sipes (40) of the first row (1) may originate at the circumferentially continuous groove (20) and the sipes (40) of the second row (2) may originate at the circumferentially continuous groove (24) and both rows may extend axially inward and circumferentially (e.g., curved, inclined, etc.) to a circumferentially extending and continuous variable center groove (100). As shown in FIGS. 2 and 3, the center groove (100) has a narrow opening at its radially outermost portion. As shown in FIGS. 2 and 4, as the tire (10) wears, the opening widens as the radially outermost portion of the center groove (100) moves radially inward.

As shown in FIGS. 1 through 4, the shoulders of the tread (222) adjacent each lateral tread edge (14, 16) may have first and second circumferentially extending shoulder ribs (34, 36). The first rib (34) may have a first set (11) of circumferentially spaced sipes (201) and a second set (12) of circumferentially spaced sipes (202). Each sipe (201) of the first set (11) may originate at the circumferentially continuous groove (20) and may extend axially and circumferentially (e.g., curved, inclined, etc.) across the first rib (34) to a circumferentially extending and continuous variable first groove (61), similar to the variable center groove (100). Each sipe (202) of the second set (12) may originate at the variable first groove (61) and may extend axially and circumferentially (e.g., curved, inclined, etc.) across the first rib (34) and may end prior to reaching the first lateral edge (14) of the tire (10).

The second rib (36) may have a first set (21) of circumferentially spaced sipes (301) and a second set (22) of circumferentially spaced grooves (302). Each sipe (301) of the first set (21) may originate at the circumferentially continuous groove (24) and may extend axially and circumferentially (e.g., curved, inclined, etc.) across the second rib (36) to a circumferentially extending and continuous variable second groove (62), similar to the variable center groove (100). Each sipe (302) of the second set (22) may originate at the variable second groove (62) and may extend axially and circumferentially (e.g., curved, inclined, etc.) across the second rib (36) and may end prior to reaching the second lateral edge (16) of the tire (10).

The example tire (10) may be utilized for highway and long haul truck applications. The example tire (10) and tread (222) may optimize treadwear, rolling resistance, and wet braking performance, thereby reducing fuel consumption and environmental impact. Nonskid, Tread Arc Radius, Net to Gross, density, depth, and orientation of the sipes have been considered in choosing the example tread (222). Compared with a similar conventional tire and tread, the example tire (10) and tread (222) may show a rolling resistance decrease of as much as 15 percent, while keeping same mileage potential and wet skid performance.

The circumferentially continuous grooves (20, 24) may have a 7.6 mm depth and the variable grooves (61, 62, 100) may have a 13.6 mm depth with the three variable grooves (61, 62, 100) widening as the tire (10) wears and the circumferentially continuous grooves (20, 24) ending (FIG. 4). The example shoulder ribs (34, 36) may provide less shoulder wear and increased robustness during maneuvering. The grooves (20, 24, 61, 62, 100) may have large radii at their bases for decreasing crack probability. The sipes (40, 201, 202, 301, 302) may have depths of 100 percent the depth of the grooves (20, 24) for improved wet skid performance and wear evenness. The mold shape may be tuned by finite element analysis for optimizing the shape of the footprint and balancing pressure distribution thereby smoothing the wear profile and maximizing mileage potential.

As stated above, the tire (10) and tread (222) in accordance with the present invention may provide excellent rolling resistance, wear, and traction characteristics. This tread (222) thus enhances the performance of the tire (10), even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the tread, typically made up a polymeric material molded into a specific tread pattern. Id. at 207 through 208.

These complexities are demonstrated by the below table of the interrelationships between tire performance and tire components.

| | | CARCASS | | BELT | | | |
|---|---|---|---|---|---|---|---|
| | LINER | PLY | APEX | PLY | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, the tread characteristics affect the other components of a pneumatic tire (e.g., tread affects carcass ply, apex, belt ply, overlay, etc.), leading to a number of components interrelating and interacting in such a way as to affect a group of functional properties (e.g., treadwear, noise, handling, traction, durability, rolling resistance, comfort, high speed, and mass in two modes of operation, inflated and deflated), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the tread pattern of a pneumatic tire is modified with the intent to improve one functional property of the pneumatic tire, any number of other functional properties may be unacceptably degraded. Furthermore, the interaction between the tread pattern and the carcass ply, belt ply, overlay, and tread may also unacceptably affect the functional properties of the pneumatic tire. A modification of the tread pattern may not even improve that one functional property (e.g., treadwear) because of these complex interrelationships.

Thus, as stated above, the complexity of the interrelationships of the multiple components makes the actual result of modification of a tread pattern in accordance with the present invention, impossible to predict or foresee from the infinite possible results. Only through extensive experimentation has the tread pattern of the present invention been revealed as an excellent, albeit unexpected and unpredictable, option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

1. A tread for a pneumatic tire comprising:
a first circumferentially continuous groove;
a second circumferentially continuous groove;
a central rib interposed between the two circumferentially continuous grooves, the central rib extending continuously around a circumference of the tread;
a first circumferentially extending shoulder rib disposed laterally outside of the first circumferentially continuous groove;
a second circumferentially extending shoulder rib disposed laterally outside of the second circumferentially continuous groove;
the central rib having a plurality of circumferentially spaced sipes arranged in a first circumferential row and a second circumferential row, the sipes of the first row originating at the first circumferentially continuous groove and the sipes of the second row originating at the second circumferentially continuous groove, the sipes of both the first and second rows extending axially inward to a circumferentially extending and continuous variable center groove, the variable center groove having a minimum circumferentially extending opening at a radially outermost portion;
as the tread wears and the radially outermost portion of the tread moves radially inward, the circumferentially extending opening of the variable center groove widens to a maximum circumferentially extending opening greater than the minimum circumferentially extending opening,
a circumferentially extending and continuous variable first groove disposed in the first shoulder rib, a circumferentially extending and continuous variable second groove disposed in the second shoulder rib,
the first groove has an axial width increasing from a surface of the first shoulder rib radially inward toward an axis of rotation of the tire, the second groove has an axial width increasing from a surface of the second shoulder rib radially inward toward an axis of rotation of the tire,
the variable center groove having an axial width increasing from a surface of the center rib radially inward toward an axis of rotation of the tire,
the first rib having a first set of circumferentially spaced sipes and a second set of circumferentially spaced sipes, the second rib having a first set of circumferentially spaced sipes and a second set of circumferentially spaced sipes.

2. (canceled)

3. (canceled)

4. (canceled)

5. (canceled)

6. (canceled)

7. (canceled)

8. (canceled)

9. The tread as set forth in claim 1 wherein the first and second circumferentially continuous grooves have a 7.6 mm radial depth.

10. The tread as set forth in claim 9 wherein the sipes of the first and second ribs have a radial depth of 100 percent the radial depth of the first and second circumferentially continuous grooves.

11. A pneumatic tire comprising:
a pair of annular bead cores;
a carcass extending around the bead cores to form a toroidal structure;
a belt reinforcing structure radially outward of the carcass;
a circumferentially extending tread radially outward of the belt reinforcing structure;
the tread including a first circumferentially continuous groove, a second circumferentially continuous groove, a central rib interposed between the two circumferentially continuous grooves,
the central rib extending continuously around a circumference of the tread, a first circumferentially extending shoulder rib disposed laterally outside of the first circumferentially continuous groove, and a second circumferentially extending shoulder rib disposed laterally outside of the second circumferentially continuous groove;
the central rib having a plurality of circumferentially spaced sipes arranged in a first circumferential row and a second circumferential row, the sipes of the first row originating at the first circumferentially continuous groove and the sipes of the second row originating at the second circumferentially continuous groove, the sipes of both the first and second rows extending axially inward to a circumferentially extending and continuous variable center groove, the variable center groove having a minimum circumferentially extending opening at a radially outermost portion;
as the tread wears and the radially outermost portion of the tread moves radially inward, the circumferentially extending opening of the variable center groove widens to a maximum circumferentially extending opening greater than the minimum circumferentially extending opening,
a circumferentially extending and continuous variable first groove disposed in the first shoulder rib, a circumferentially extending and continuous variable second groove disposed in the second shoulder rib,
the first groove having an axial width increasing from a surface of the first shoulder rib radially inward toward an axis of rotation of the tire, the second groove having an axial width increasing from a surface of the second shoulder rib radially inward toward an axis of rotation of the tire,
the variable center groove has an axial width increasing from a surface of the center rib radially inward toward an axis of rotation of the tire, the first rib having a first set of circumferentially spaced sipes and a second set of circumferentially spaced sipes, the second rib having a first set of circumferentially spaced sipes and a second set of circumferentially spaced sipes.

12. (canceled)

13. (canceled)

14. (canceled)

15. (canceled)

16. (canceled)

17. (canceled)

18. (canceled)

19. The pneumatic tire as set forth in claim 11, wherein the first and second circumferentially continuous grooves have a 7.6 mm radial depth.

20. The pneumatic tire as set forth in claim 19 wherein the sipes of the first and second ribs have a radial depth of 100 percent the radial depth of the first and second circumferentially continuous grooves.
